(19) United States
(12) Patent Application Publication
(10) Pub. No.: US 2026/0016022 A1
(43) Pub. Date: Jan. 15, 2026

(54) FAN UNIT AND OUTDOOR UNIT

(71) Applicant: DAIKIN INDUSTRIES, LTD., Osaka-shi (JP)

(72) Inventors: Zuozhou CHEN, Osaka-shi (JP); Ryusuke OTAGURO, Osaka-shi (JP); Kaname MARUYAMA, Osaka-shi (JP)

(21) Appl. No.: 19/335,973

(22) Filed: Sep. 22, 2025

Related U.S. Application Data
(63) Continuation of application No. PCT/JP2024/012417, filed on Mar. 27, 2024.

(30) Foreign Application Priority Data
Mar. 28, 2023 (JP) 2023-052001

(51) Int. Cl. F04D 29/38; F04D 19/00

(52) U.S. Cl. CPC F04D 29/388; F04D 19/002

(57) ABSTRACT

A fan unit includes an axial fan, and a bell mouth. The axial fan includes a hub attached to a rotation shaft, a blade arranged on the hub, and a turbulent-flow interference portion. The turbulent-flow interference portion includes an overlapping part where the blade overlaps the bell mouth in a radial direction of the axial fan, and an extension part located at two opposite sides of the overlapping part in an axial direction of the axial fan. A length of the extension part in the axial direction is less than or equal to 0.1 times a radius of the axial fan. The blade includes a porous part within a range of the turbulent-flow interference portion. An area of the porous part being less than or equal to 30% of an area of the blade.

### CROSS-REFERENCE TO RELATED APPLICATIONS

This application is a continuation of, and claims the benefit of priority from International Application No. PCT/JP2024/012417, filed on Mar. 27, 2024, which claims the benefit of priority from Japanese Patent Application No. 2023-052001, filed on Mar. 28, 2023, the entire contents of each are incorporated herein by reference.

### BACKGROUND

### Technical Field

The present disclosure relates to a fan unit and an outdoor unit.

### Background Information

Japanese Patent No. 2754862 discloses an axial fan including porous sections. The axial fan of Japanese Patent No. 2754862 including the porous sections restricts pressure fluctuations and reduces noise.

### SUMMARY

A fan unit in one general aspect includes an axial fan and a bell mouth. The axial fan includes a hub attached to a rotation shaft, and a blade arranged on the hub. The axial fan includes a turbulent-flow interference portion. The turbulent-flow interference portion includes an overlapping part and an extension part. In the overlapping part, the blade overlaps the bell mouth in a radial direction of the axial fan. The extension part is located at two opposite sides of the overlapping part in an axial direction of the axial fan. A length of the extension part in the axial direction is less than or equal to 0.1 times a radius of the axial fan. The blade includes a porous part within a range of the turbulent-flow interference portion. An area of the porous part is less than or equal to 30% of an area of the blade.

### BRIEF DESCRIPTION OF DRAWINGS

FIG. 1 is a schematic front view showing the inside of an outdoor unit including a fan unit.

FIG. 2 is a schematic cross-sectional view showing part of the fan unit shown in FIG. 1.

FIG. 3 is a perspective view of a bell mouth shown in FIG. 2.

FIG. 4 is a front view of an axial fan shown in FIG. 2 as viewed from the side of a positive pressure surface.

FIG. 5 is a cross-sectional view of a blade taken along line D5-D5 shown in FIG. 4.

FIG. 6 is an enlarged view of the axial fan shown in FIG. 4.

FIG. 7 is a graph showing the level of noise reduction effect with respect to a ratio of a length of an extension part to a radius of the axial fan.

FIG. 8 is a graph showing the level of the noise reduction effect with respect to a position of a porous part arranged in the blade.

FIG. 9 is a front view of an axial fan in accordance with a second embodiment as viewed from the side of a positive pressure surface.

FIG. 10 is an enlarged view of a blade in accordance with the second embodiment.

FIG. 11 is a schematic cross-sectional view showing part of a fan unit in accordance with a third embodiment.

FIG. 12 is a front view of an axial fan in accordance with the third embodiment as viewed from the side of a positive pressure surface.

FIG. 13 is a graph showing the level of noise reduction effect by the axial fan in accordance with the third embodiment with respect to a ratio of a length from an upstream end of a bell mouth to a third end relative to a length of a first extension part.

FIG. 14 is a graph showing the level of maximum stress on a blade with respect to a ratio of an area of a porous part to an area of the blade.

### DETAILED DESCRIPTION OF EMBODIMENT(S)

### First Embodiment

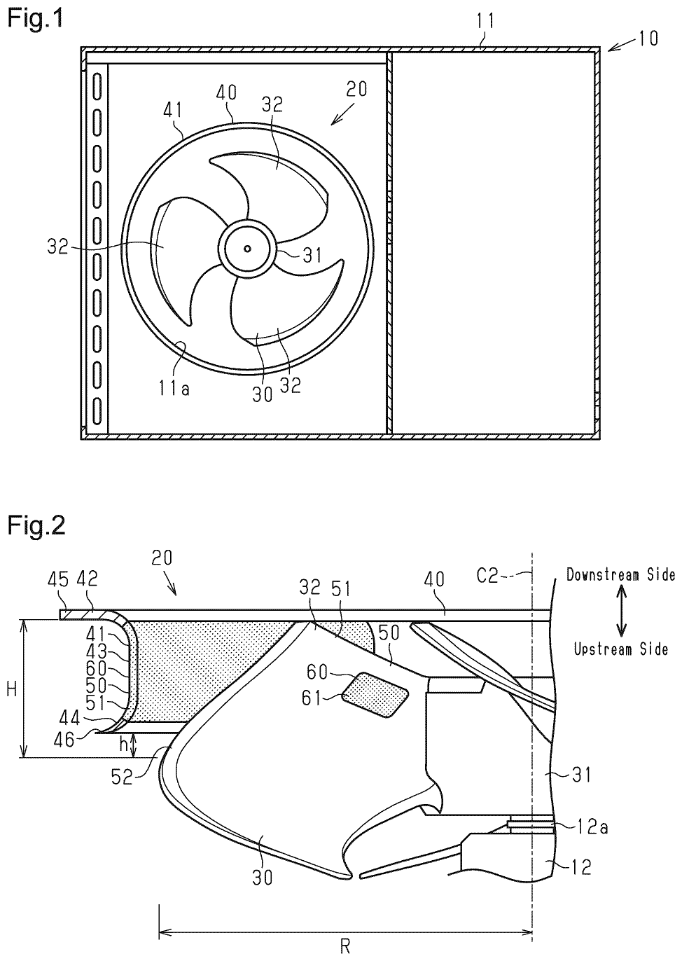

A first embodiment of a fan unit will now be described with reference to FIGS. 1 to 6.

### Outdoor Unit

An outdoor unit 10 will be described with reference to FIGS. 1 and 2. The outdoor unit 10 of the present embodiment is an outdoor unit for an air conditioner that cools and heats the living space inside a room. The outdoor unit 10 is connected to an indoor unit by a refrigerant pipe. The outdoor unit 10 includes a fan unit 20 and a case 11. There is no limitation on the shape of the case 11. For example, the case 11 has the form of a laterally elongated box. The fan unit 20 is accommodated in the case 11.

### Fan Unit

The fan unit 20 includes an axial fan 30 and a bell mouth 40. The bell mouth 40 is arranged on an outlet 11a of the case 11. The bell mouth 40 is disposed around the axial fan 30 so as to surround the axial fan 30. The axial fan 30 is connected to a rotation shaft 12a of an axial fan motor 12. The axial fan motor 12 is arranged in the case 11.

The fan unit 20 is configured to draw in air through an inlet (not shown) of the case 11 and blow out the air from the outlet 11a of the case 11. The fan unit 20 is used as, for example, an air blowing device.

### Bell Mouth

As shown in FIGS. 1 to 3, the bell mouth 40 is accommodated in the case 11 in a state attached to the circumference of the outlet 11a of the case 11. The bell mouth 40 has a circumferential wall 41 that is ring-shaped as viewed from the front. The circumferential wall 41 includes a blow-out portion 42, a cylindrical portion 43, and a suction portion 44. In the following description of the present embodiment, an upstream side refers to the upstream side of the airflow generated by the axial fan 30, and a downstream side refers to the downstream side of the airflow generated by the axial fan 30.

The blow-out portion 42 is located at a downstream end 45 of the bell mouth 40. The blow-out portion 42 is curved such that an inner diameter of the blow-out portion 42 decreases toward an upstream end 46 of the bell mouth 40. The cylindrical portion 43 continuously extends from an upstream end of the blow-out portion 42 toward the upstream end 46 of the bell mouth 40. The cylindrical portion 43 has an inner diameter that is constant from the upstream end of the blow-out portion 42 to a downstream end of the suction portion 44. The cylindrical portion 43 has an axis that coincides with an axis C1 of the bell mouth 40.

The suction portion 44 continuously extends from an upstream end of the cylindrical portion 43. The suction portion 44 is curved such that an inner diameter of the suction portion 44 increases from the upstream end of the cylindrical portion 43 toward the upstream end 46 of the bell mouth 40.

There is no limitation to the thickness of the circumferential wall 41. The thickness of the circumferential wall 41 is, for example, greater than or equal to 1 mm. Preferably, the thickness of the circumferential wall 41 is greater than or equal to 2 mm. The thickness of the circumferential wall 41 is, for example, less than or equal to 10 mm. Preferably, the thickness of the circumferential wall 41 is less than or equal to 5 mm. Preferably, the thickness of the circumferential wall 41 is in a range of 2 mm to 5 mm, inclusive.

There is no limitation to the material of the circumferential wall 41. The material of the circumferential wall 41 is, for example, resin, ceramic, metal, or the like. Preferably, the material of the circumferential wall 41 is resin so that the resin reduces the weight of the bell mouth 40 while maintaining the strength of the bell mouth 40.

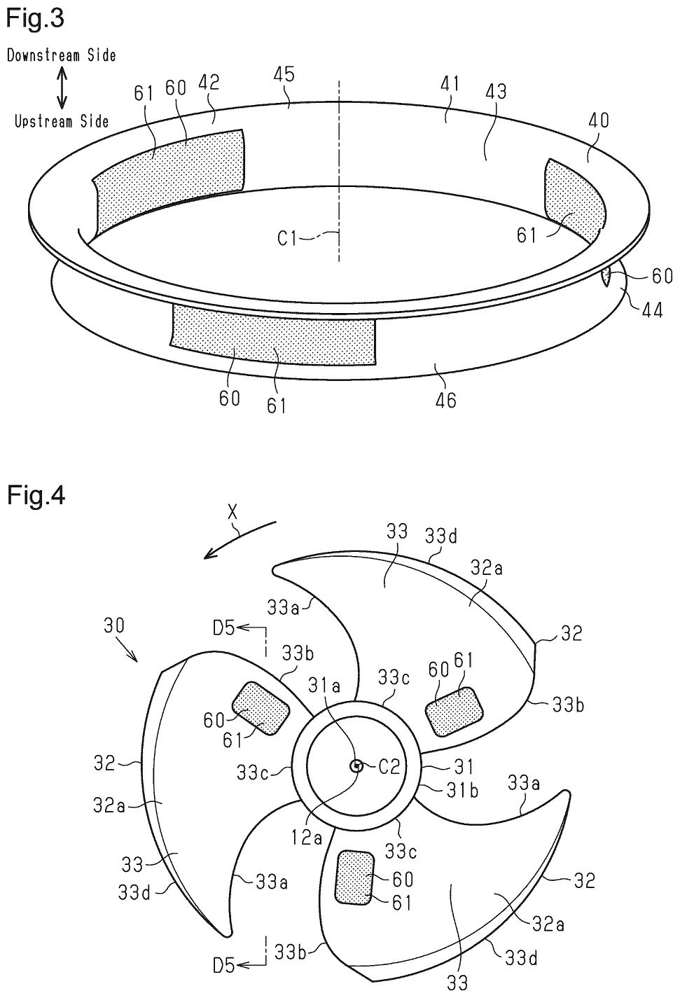

As shown in FIGS. 2 and 3, the bell mouth 40 includes a pressure-fluctuating-element passing part 60. In FIGS. 2 and 3, the pressure-fluctuating-element passing part 60 is dotted. The details of the pressure-fluctuating-element passing part 60 will be described later.

### Axial Fan

As shown in FIGS. 2 and 4, the axial fan 30 includes a hub 31 and a blade 32. The hub 31 is cylindrical. The material of the hub 31 is, for example, resin. The hub 31 includes an insertion hole 31a and an outer circumferential surface 31b. The hub 31 has an axis that coincides with an axis C2 of the axial fan 30. The insertion hole 31a is located in the center of the hub 31. The insertion hole 31a receives the rotation shaft 12a of the axial fan motor 12. Driving force of the axial fan motor 12 rotates the axial fan 30 in one direction. The axial fan 30 rotates in a rotation direction X as the rotation shaft 12a rotates. The rotation direction X is the rotation direction of the rotation shaft 12a.

The number of blades 32 is five or less. The number of blades 32 is, for example, three. The number of blades 32 may be five, four, or two. The blades 32 are arranged on the outer circumferential surface 31b of the hub 31. The blades 32 each extend from the outer circumferential surface 31b in a radial direction of the hub 31. The radial direction of the hub 31 corresponds to a direction orthogonal to the rotation shaft 12a of the axial fan motor 12. A radial direction of the axial fan 30 coincides with the radial direction of the hub 31. The blades 32 are spaced apart from one another in the rotation direction X. The three blades 32 have the same shape.

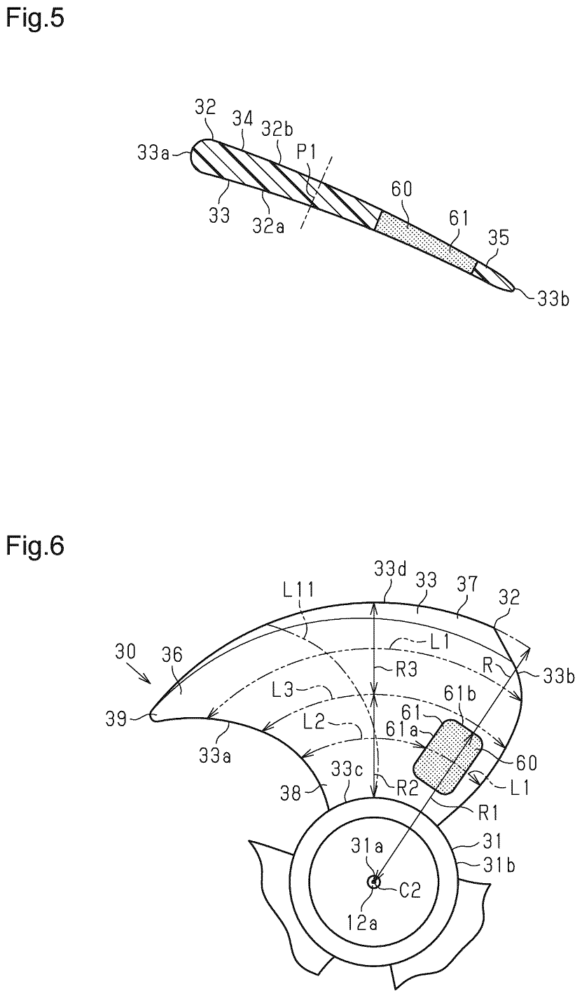

As shown in FIG. 5, each of the blades 32 includes a positive pressure surface 32a and a negative pressure surface 32b. The positive pressure surface 32a is a blade surface located at a positive pressure side of the airflow generated by the rotation of the axial fan 30. The negative pressure surface 32b is a blade surface located at a negative pressure side of the airflow generated by the rotation of the axial fan 30. When the blade 32 includes a porous part 61, the pores in the porous part 61 extend between the positive pressure surface 32a and the negative pressure surface 32b. Air flows out of the porous part 61 at the side of the positive pressure surface 32a as the axial fan 30 rotates. Air flows into the porous part 61 at the side of the negative pressure surface 32b as the axial fan 30 rotates.

As shown in FIGS. 2 and 4, the blade 32 has a body 33. The material of the body 33 is, for example, resin. The hub 31 is formed integrally with the body 33. The hub 31 is formed integrally with the body 33, for example, by injection molding. The blade 32 includes the porous part 61. The porous part 61 is included in the pressure-fluctuating-element passing part 60. In FIGS. 2 and 4 to 6, the porous part 61 is dotted. The porous part 61 is located in a turbulent-flow interference portion 50 of the axial fan 30. The details of the turbulent-flow interference portion 50 and the porous part 61 will be described later.

The body 33 includes a leading edge 33a, a trailing edge 33b, an inner peripheral edge 33c, and an outer peripheral edge 33d. The leading edge 33a is an edge located forward with respect to the rotation direction X. The trailing edge 33b is an edge located rearward with respect to the rotation direction X. The leading edge 33a is curved. The leading edge 33a is curved in an arcuate manner so as to be recessed toward the trailing edge 33b. The trailing edge 33b is curved. The trailing edge 33b is curved in an arcuate manner toward the trailing side with respect to the rotation direction X. The inner peripheral edge 33c is joined to the hub 31. The inner peripheral edge 33c extends between the leading edge 33a and the trailing edge 33b. The outer peripheral edge 33d extends between the leading edge 33a and the trailing edge 33b. In the radial direction of the axial fan 30, a dimension of the hub 31 from the rotation shaft 12a to the inner peripheral edge 33c is smaller than a dimension of the hub 31 from the rotation shaft 12a to the outer peripheral edge 33d. The outer peripheral edge 33d is curved. The outer peripheral edge 33d is curved in an arcuate manner so as to project in the radial direction of the axial fan 30.

As shown in FIG. 6, a dimension from the leading edge 33a to the trailing edge 33b will be referred to as a first dimension L1. The first dimension L1 is a length of an imaginary line formed by connecting points located at the same distance from the axis C2 of the axial fan 30 in the radial direction of the axial fan 30 between the leading edge 33a and the trailing edge 33b. More specifically, when an arbitrary circle is drawn around the axis C2 of the axial fan 30, the first dimension L1 is a length of the arc extending between the leading edge 33a and the trailing edge 33b on a single blade 32. The first dimension L1 varies depending on the distance from the axis C2 of the axial fan 30 in the radial direction of the axial fan 30.

A leading edge section 34 and a trailing edge section 35 of the blade 32 will now be described with reference to FIG. 5. The blade 32 is divided into the leading edge section 34 and the trailing edge section 35 by an imaginary line formed by connecting the center points of multiple first dimensions L1. For example, a section of the blade 32 between a center position P1 of the first dimensions L1 and the leading edge 33a is the leading edge section 34, and a section of the blade 32 between the center position P1 of the first dimensions L1 and the trailing edge 33b is the trailing edge section 35. The leading edge section 34 is heavier than the trailing edge section 35. For example, the leading edge section 34 is heavier than the trailing edge section 35 because the body 33 gradually becomes thicker from the trailing edge 33b toward the leading edge 33a. The leading edge section 34 may be heavier than the trailing edge section 35 because the leading edge section 34 is partially thicker than the trailing edge section 35.

### Turbulent-Flow Interference Portion

The axial fan 30 and the bell mouth 40 each include the turbulent-flow interference portion 50. The turbulent-flow interference portion 50 includes, for example, part of the axial fan 30 or part of the bell mouth 40 that is likely to interfere with turbulent flow when pressure fluctuations occur in the air flowing between the bell mouth 40 and the axial fan 30.

As shown in FIG. 2, the turbulent-flow interference portion 50 is located on the axial fan 30 or the bell mouth 40. The turbulent-flow interference portion 50 may be located on the axial fan 30 and/or in the bell mouth 40. The turbulent-flow interference portion 50 may be located on both the axial fan 30 and the bell mouth 40. The turbulent-flow interference portion 50 includes an overlapping part 51 and an extension part 52.

The overlapping part 51 is where the blade 32 overlaps the bell mouth 40 in the radial direction of the axial fan 30. For example, when an imaginary cylindrical body formed by the trajectory of the rotation of the blade 32 is projected onto the bell mouth 40, the overlapping part 51 of the bell mouth 40 is defined where the imaginary cylindrical body overlaps the bell mouth 40 in the radial direction of the axial fan 30. More specifically, when an imaginary cylindrical body formed by the trajectory of the outer peripheral edge 33d of the blade 32 is projected onto the bell mouth 40, the overlapping part 51 of the bell mouth 40 is defined where the imaginary cylindrical body overlaps the bell mouth 40 in the radial direction of the axial fan 30. The overlapping part 51 of the blade 32 is defined where the bell mouth 40 overlaps the blade 32 when the bell mouth 40 is projected onto the blade 32 in the radial direction of the axial fan 30.

The overlapping part 51 is located on the bell mouth 40 and the axial fan 30. The overlapping part 51 varies depending on the positional relationship of the axial fan 30 and the bell mouth 40. For example, a portion of the bell mouth 40 that corresponds to the overlapping part 51 includes the cylindrical portion 43, part of the blow-out portion 42, and part of the suction portion 44 of the bell mouth 40. For example, a portion of the axial fan 30 that corresponds to the overlapping part 51 includes part of the trailing edge section 35 of the blade 32.

The extension part 52 is located at the upstream side and the downstream side of the overlapping part 51. In other words, the extension part 52 is located at two opposite sides of the overlapping part 51 in the axial direction of the axial fan 30. The extension part 52 may be located on only one side of the overlapping part 51 in the axial direction of the axial fan 30.

The extension part 52 varies depending on the positional relationship of the axial fan 30 and the bell mouth 40. In FIG. 3, the blow-out portion 42 and the suction portion 44 are curved so as to expand in a radial direction of the bell mouth 40. Thus, turbulent flow will not interfere with the blow-out portion 42 or the suction portion 44. Accordingly, the bell mouth 40 does not have a portion corresponding to the extension part 52. The extension part 52 of the axial fan 30 includes part of the trailing edge section 35 of the blade 32. The extension part 52 of the axial fan 30 may include part of the leading edge section 34 of the blade 32.

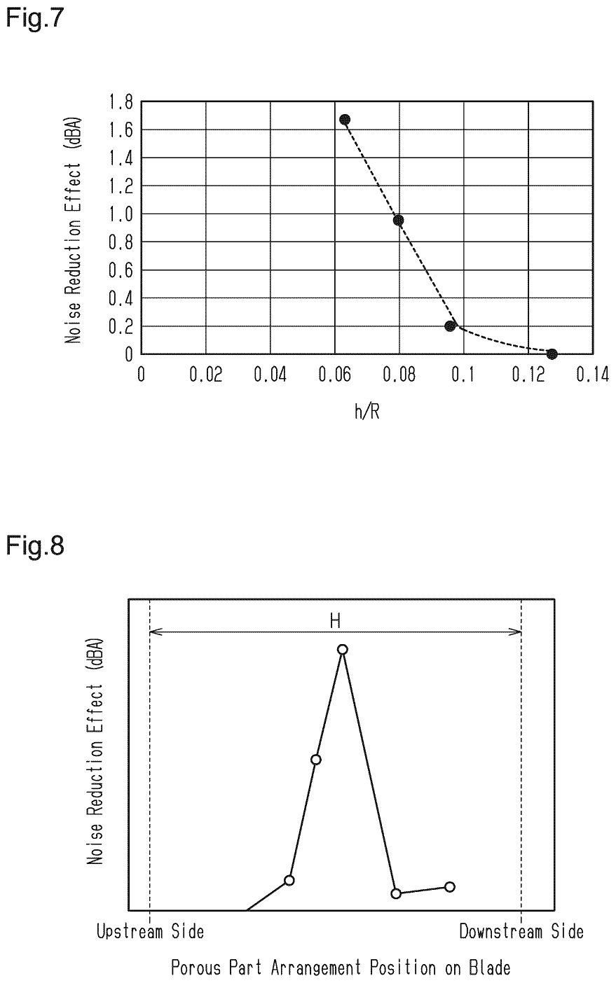

The relationship between a length h of the extension part 52 in the axial direction of the axial fan 30 and a radius R of the axial fan 30 will now be described with reference to FIG. 7. FIG. 7 shows the level of noise reduction effect with respect to a ratio of the length h of the extension part 52 to the radius R of the axial fan 30. The graph in FIG. 7 was obtained through experiments. As shown in FIG. 7, the wind noise was minimized when the length h was set to less than or equal to 0.1 times the radius R. Therefore, it is preferred that the length h of the extension part 52 in the axial direction of the axial fan 30 be less than or equal to 0.1 times the radius R of the axial fan 30.

As shown in FIG. 2, the blade 32 or the bell mouth 40 each include the pressure-fluctuating-element passing part 60 within the range of the turbulent-flow interference portion 50. In other words, the axial fan 30 or the bell mouth 40 each include the pressure-fluctuating-element passing part 60 within a range of a portion corresponding to the turbulent-flow interference portion 50. It is preferred that the pressure-fluctuating-element passing part 60 is entirely arranged within the range of respective turbulent-flow interference portion 50.

### Pressure-Fluctuating-Element Passing Part and Porous Part

The pressure-fluctuating-element passing part 60 and the porous part 61 will now be described with reference to FIGS. 2 to 6 and 8. The pressure-fluctuating-element passing part 60 is configured to reduce pressure fluctuations that occur between the axial fan 30 and the bell mouth 40. The pressure-fluctuating-element passing part 60 is arranged in the blade 32 of the axial fan 30 or the circumferential wall 41 of the bell mouth 40. In the present embodiment, the pressure-fluctuating-element passing part 60 is arranged in both the blade 32 and the circumferential wall 41.

When the bell mouth 40 includes the pressure-fluctuating-element passing part 60 within the range of the turbulent-flow interference portion 50, the pressure-fluctuating-element passing part 60 is arranged intermittently in the circumferential direction of the bell mouth 40. For example, a plurality of pressure-fluctuating-element passing parts 60 are arranged at intervals in the circumferential direction of the bell mouth 40. For example, the plurality of pressure-fluctuating-element passing parts 60 are arranged at equal intervals in the circumferential direction of the bell mouth 40.

The number of pressure-fluctuating-element passing parts 60 arranged in a portion of the circumferential wall 41 corresponding to the turbulent-flow interference portion 50 is equal to, for example, the number of blades 32. As shown in FIG. 3, three pressure-fluctuating-element passing parts 60 are arranged in the circumferential wall 41 of the bell mouth 40 in the circumferential direction. For example, each of the pressure-fluctuating-element passing parts 60 extends over the cylindrical portion 43, part of the blow-out portion 42, and part of the suction portion 44 of the circumferential wall 41.

The surface of the pressure-fluctuating-element passing part 60 is flush with the surface of the blow-out portion 42, the surface of the cylindrical portion 43, and the surface of the suction portion 44 of the circumferential wall 41. The pressure-fluctuating-element passing part 60 has substantially the same thickness as the portions of the circumferential wall 41 other than the pressure-fluctuating-element passing part 60.

The pressure-fluctuating-element passing part 60 is formed by a porous body. The porous body extends through the circumferential wall 41 in a thickness-wise direction. The porous body has pores that are continuous with the outside of the porous body. The pores are holes that extend through the circumferential wall 41 in the thickness-wise direction. There is no limitation to the average pore diameter of the pores. The average pore diameter of the pores is preferably 1000 μm or less, and more preferably 700 μm or less. The average pore diameter may be measured by any method. The average pore diameter may be measured, for example, by a gas adsorption method, which is also referred to as a Brunauer-Emmett-Teller (BET) method.

There is no limitation to the material of the pressure-fluctuating-element passing part 60. The material of the porous body is, for example, resin, ceramic, metal, or the like. The resin is, for example, foamed plastic. The ceramic or metal is, for example, a porous sintered body. The metal may be a net-shaped body, which is also referred to as a mesh. Preferably, the material of the porous body is a porous sintered body so that the average pore diameter can be easily controlled.

The pressure-fluctuating-element passing part 60 may be arranged in the circumferential wall 41 of the bell mouth 40 by any method. For example, an opening may be formed in the circumferential wall 41 of the bell mouth 40 for fitting the pressure-fluctuating-element passing part 60, and the pressure-fluctuating-element passing part 60 having a predetermined shape may be fitted to the opening. The pressure-fluctuating-element passing part 60 may be attached to a portion of the bell mouth 40 corresponding to the opening in the circumferential wall 41 using a known adhesive. The pressure-fluctuating-element passing part 60 may be formed in the bell mouth 40 by insert molding.

When the blade 32 includes the pressure-fluctuating-element passing part 60, the pressure-fluctuating-element passing part 60 includes the porous part 61. The material of the porous part 61 is, for example, resin, ceramic, metal, or the like. The resin is, for example, foamed plastic. The ceramic or metal is, for example, a porous sintered body. The metal may be a net-shaped body, which is also referred to as a mesh. Preferably, the material of the porous part 61 is a porous sintered body so that the average pore diameter can be easily controlled.

The porous part 61 has a lower strength than the body 33. The porous part 61 is located in a region surrounded by the leading edge 33a, the trailing edge 33b, the inner peripheral edge 33c, and the outer peripheral edge 33d. The porous part 61 is entirely surrounded by the body 33 having a higher strength than the porous part 61. The porous part 61 includes pores extending between the positive pressure surface 32a and the negative pressure surface 32b and are continuous with the outside of the porous part 61. The average pore diameter of the pores is preferably 1000 μm or less, and more preferably 700 μm or less. For example, the porous part 61 has a thickness of 5 mm or less. The porous part 61 is integrated with the body 33. The porous part 61 is integrated with the body 33 by, for example, insert molding, adhesion, or fitting.

The porous part 61 is quadrangular. The porous part 61 includes, for example, four curved corners. As shown in FIG. 6, a length of an imaginary line formed by connecting points located at the same distance from the axis C2 of the axial fan 30 in the radial direction of the axial fan 30 between the leading edge 33a and the porous part 61 will be referred to as an arrangement distance L2. When an arbitrary circle is drawn around the axis C2 of the axial fan 30, for example, the arrangement distance L2 is a length of the arc extending between the leading edge 33a and a first end 61a of the porous part 61 that is located toward the leading edge 33a on a single blade 32. Expression (1) is satisfied at points where the distance from the rotation shaft 12a in the radial direction are the same.

$$\{ ( L 2 / L 1 ) \times 100 \} \geq 40 \qquad Expression ( 1 )$$

Expression (1) indicates that the porous part 61 is located at a position rearward from the leading edge 33a by 40% or more of the first dimension L1. FIG. 6 shows a border L11 that lies along positions located rearward from the leading edge 33a by 40% of the first dimensions L1. A first region 36 is defined between the leading edge 33a and the border L11. A second region 37 is defined between the border L11 and the trailing edge 33b. The second region 37 includes the border L11. The porous part 61 is located only in the second region 37. The porous part 61 is not located in the first region 36.

In the present embodiment, the first dimension L1 and the arrangement distance L2 both vary depending on the distance from the rotation shaft 12a in the radial direction. In this case, the porous part 61 of the present embodiment is located within the range of the turbulent-flow interference portion 50 and where Expression (1) is satisfied.

As shown in FIG. 6, the radius R corresponds to a distance from the axis C2 of the axial fan 30 to the outer peripheral edge 33d or an imaginary extension line of the outer peripheral edge 33d. A distance from the inner peripheral edge 33c to a second end 61b of the porous part 61 that is located toward the outer peripheral edge 33d will be referred to as a first blade length R1. The relationship of the radius R and the first blade length R1 satisfies Expression (2). Expression (2) indicates that the porous part 61 is arranged in a portion of the blade 32 located within 70% of the radius R of the axial fan 30 from the rotation shaft 12a in the radial direction of the axial fan 30.

$$\{ ( R 1 / R ) \times 100 \} \geq 70 \qquad Expression ( 2 )$$

The porous part 61 is arranged in the blade 32 to reduce the noise caused by the rotation of the axial fan 30. When the bell mouth 40 includes the pressure-fluctuating-element passing part 60 and the blade 32 includes the porous part 61, the noise reduction effect obtained by the porous part 61 is affected by the position of the porous part 61 in the range of the turbulent-flow interference portion 50. As shown in FIG. 2, a dimension of the turbulent-flow interference portion 50 from the upstream end to the downstream end will be referred as an axial length H. The axial length H is a dimension obtained by adding the length of the overlapping part 51 in the axial direction and the length h of the extension part 52. As shown in FIG. 8, the noise reduction effect was observed when the porous part 61 was located near the middle point of the turbulent-flow interference portion 50 of the blade 32 with respect to the axial length H.

As shown in FIG. 6, one of the imaginary lines defining the first dimensions L1 that extends through the middle point of the blade 32 will be referred to as a middle first dimension L3. A distance from the inner peripheral edge 33c to the middle first dimension L3 in the radial direction of the axial fan 30 will be referred to as a second blade length R2. A distance from the middle first dimension L3 to the outer peripheral edge 33d in the radial direction of the axial fan 30 will be referred to as a third blade length R3. When the blade 32 is divided into an inner peripheral region 38 and an outer peripheral region 39, a portion of the blade 32 corresponding to the second blade length R2 is the inner peripheral region 38. When the blade 32 is divided into the inner peripheral region 38 and the outer peripheral region 39, a portion of the blade 32 corresponding to the third blade length R3 is the outer peripheral region 39. The inner peripheral region 38 is closer to the hub 31 than the outer peripheral region 39 is to the hub 31. The outer peripheral region 39 is closer to the outer peripheral edge 33d than the inner peripheral region 38 is to the outer peripheral edge 33d.

Table 1 indicates a difference in the noise reduction effect when the pressure-fluctuating-element passing part 60 is arranged in both the turbulent-flow interference portion 50 of the bell mouth 40 and the turbulent-flow interference portion 50 of the blade 32, and the porous part 61 is located on different positions of the turbulent-flow interference portion 50 of the blade 32. The “Noise Reduction Effect” of Table 1 indicates values representing the reduced noise. The “Combined Use” of Table 1 refers to a case in which the pressure-fluctuating-element passing part 60 was arranged in both the bell mouth 40 and the blade 32. In a first example of Table 1, the position of the porous part 61 on the turbulent-flow interference portion 50 of the blade 32 was in the outer peripheral region 39 of the blade 32. In a second example of Table 1, the position of the porous part 61 on the turbulent-flow interference portion 50 of the blade 32 was in the trailing edge section 35 of the blade 32.

As the second row of Table 1 indicates, when the pressure-fluctuating-element passing part 60 was arranged in only the turbulent-flow interference portion 50 of the bell mouth 40, the value representing the noise reduction effect was 2.0 dBA. When the pressure-fluctuating-element passing part 60 was arranged in only the turbulent-flow interference portion 50 of the blade 32 located in the outer peripheral region 39, the value representing the noise reduction effect was 2.0 dBA. When the pressure-fluctuating-element passing part 60 was arranged in both the turbulent-flow interference portion 50 of the bell mouth 40 and the turbulent-flow interference portion 50 of the blade 32 located in the outer peripheral region 39, the value representing the noise reduction effect was 3.5 dBA. In the first example, when the pressure-fluctuating-element passing part 60 was arranged in both the turbulent-flow interference portion 50 of the bell mouth 40 and the turbulent-flow interference portion 50 of the blade 32 located in the outer peripheral region 39, the value representing the noise reduction effect was less than a value obtained by adding the values of the noise reduction effect when the pressure-fluctuating-element passing part 60 was arranged in only one of the turbulent-flow interference portion 50 of the bell mouth 40 and the turbulent-flow interference portion 50 of the blade 32 located in the outer peripheral region 39.

As the fourth row of Table 1 indicates, when the pressure-fluctuating-element passing part 60 was arranged in only the turbulent-flow interference portion 50 of the bell mouth 40, the value representing the noise reduction effect was 2.0 dBA. When the pressure-fluctuating-element passing part 60 was arranged in only the turbulent-flow interference portion 50 of the blade 32 located in the trailing edge section 35, the value representing the noise reduction effect was 1.5 dBA. When the pressure-fluctuating-element passing part 60 was arranged in both the turbulent-flow interference portion 50 of the bell mouth 40 and the turbulent-flow interference portion 50 of the blade 32 located in the trailing edge section 35, the value representing the noise reduction effect was 4.0 dBA. In the second example, when the pressure-fluctuating-element passing part 60 was arranged in both the turbulent-flow interference portion 50 of the bell mouth 40 and the turbulent-flow interference portion 50 of the blade 32 located in the trailing edge section 35, the value representing the noise reduction effect was greater than a value obtained by adding the values of the noise reduction effect when the pressure-fluctuating-element passing part 60 was arranged in only one of the turbulent-flow interference portion 50 of the bell mouth 40 and the turbulent-flow interference portion 50 of the blade 32 located in the trailing edge section 35.

TABLE 1

| | Pressure-Fluctuating- | Outer | | |
|---|---|---|---|---|
| | Element Passing Part | Peripheral | Bell | Combined |
| | Arrangement Position | Region | Mouth | Use |
| 1st | Noise Reduction | 2.0 | 2.0 | 3.5 |
| Example | Effect (dBA) | | | |
| | Pressure-Fluctuating- | Trailing | | |
| | Element Passing Part | Edge | Bell | Combined |
| | Arrangement Position | Section | Mouth | Use |
| 2nd | Noise Reduction | 1.5 | 2.0 | 4.0 |
| Example | Effect (dBA) | | | |

The area of the porous part 61 is less than the area of the blade 32. For example, the entire area of the positive pressure surface 32a is greater than the area of the porous part 61. In the present embodiment, the area of the porous part 61 is less than or equal to 30% of the area of the blade 32. The area of the porous part 61 is, for example, less than or equal to 30% of the entire area of the positive pressure surface 32a.

### Operation of the First Embodiment

As indicated in Table 1, when both the axial fan 30 and the bell mouth 40 include the pressure-fluctuating-element passing part 60, the noise reduction effect is affected by the position of the porous part 61 on the axial fan 30. When the pressure-fluctuating-element passing part 60 is arranged in both the turbulent-flow interference portion 50 of the bell mouth 40 and the turbulent-flow interference portion 50 of the blade 32 located in the trailing edge section 35, the noise reduction effect becomes greater than the value obtained by combining the noise reduction effects when the pressure-fluctuating-element passing part 60 is arranged in either of the turbulent-flow interference portion 50 of the bell mouth 40 or the turbulent-flow interference portion 50 of the blade 32 located in the trailing edge section 35.

### Advantages of the First Embodiment

The first embodiment has the following advantages.

(1-1) The fan unit 20 includes the axial fan 30 and the bell mouth 40. The axial fan 30 includes the hub 31 and the blade 32. The hub 31 is attached to the rotation shaft 12a. The blade 32 is arranged on the hub 31. The axial fan 30 and the bell mouth 40 each include the turbulent-flow interference portion 50. The turbulent-flow interference portion 50 includes the overlapping part 51 and the extension part 52. In the overlapping part 51, the blade 32 overlaps the bell mouth 40 in the radial direction of the axial fan 30. The extension part 52 is located at two opposite sides of the overlapping part 51 in the axial direction of the axial fan 30. The length h of the extension part 52 in the axial direction is less than or equal to 0.1 times of the radius R of the axial fan 30. The blade 32 or the bell mouth 40 includes the pressure-fluctuating-element passing part 60 within the range of the turbulent-flow interference portion 50. The pressure-fluctuating-element passing part 60 is configured to reduce pressure fluctuations that occur between the axial fan 30 and the bell mouth 40.

With this structure, the pressure-fluctuating-element passing part 60 is arranged in the turbulent-flow interference portion 50 of the axial fan 30 or the turbulent-flow interference portion 50 of the bell mouth 40. Thus, when pressure fluctuations occur in the air flowing between the bell mouth 40 and the axial fan 30, turbulent flow readily passes through the pressure-fluctuating-element passing part 60. This minimizes the wind noise caused by surface vortex. For example, surface vortex is a vortex that occurs on the surface of the blade 32 or the surface of the circumferential wall 41 of the bell mouth 40.

(1-2) The blade 32 includes the leading edge 33a and the trailing edge 33b. The leading edge 33a is located forward with respect to the rotation direction X of the rotation shaft 12a. The trailing edge 33b is located rearward with respect to the rotation direction X of the rotation shaft 12a. When the blade 32 includes the pressure-fluctuating-element passing part 60 within the range of the turbulent-flow interference portion 50, the pressure-fluctuating-element passing part 60 includes the porous part 61. When the dimension from the leading edge 33a to the trailing edge 33b is referred to as the first dimension L1, the porous part 61 is located at a position rearward from the leading edge 33a by 40% or more of the first dimension L1.

With this structure, the porous part 61 is located rearward from the leading edge 33a by 40% or more of the first dimension L1. This reduces the noise generated near the trailing edge 33b of the blade 32.

(1-3) The fan unit 20 includes the axial fan 30 and the bell mouth 40. The axial fan 30 includes the hub 31 and the blade 32. The hub 31 is attached to the rotation shaft 12a. The blade 32 is arranged on the hub 31. The axial fan 30 and the bell mouth 40 each include the turbulent-flow interference portion 50. The turbulent-flow interference portion 50 includes the overlapping part 51 and the extension part 52. In the overlapping part 51, the blade 32 overlaps the bell mouth 40 in the radial direction of the axial fan 30. The extension part 52 is located at two opposite sides of the overlapping part 51 in the axial direction of the axial fan 30. The length h of the extension part 52 in the axial direction is less than or equal to 0.1 times of the radius R of the axial fan 30. The blade 32 and the bell mouth 40 each include the pressure-fluctuating-element passing part 60 within the range of respective turbulent-flow interference portion 50. The pressure-fluctuating-element passing part 60 is configured to reduce pressure fluctuations that occur between the axial fan 30 and the bell mouth 40. The blade 32 includes the leading edge 33a and the trailing edge 33b. The leading edge 33a is located forward with respect to the rotation direction X of the rotation shaft 12a. The trailing edge 33b is located rearward with respect to the rotation direction X of the rotation shaft 12a. The pressure-fluctuating-element passing part 60 arranged in the blade 32 includes the porous part 61. When the dimension from the leading edge 33a to the trailing edge 33b is referred to as the first dimension L1, the porous part 61 is located at a position rearward from the leading edge 33a by 40% or more of the first dimension L1.

With this structure, the pressure-fluctuating-element passing part 60 is arranged in both the turbulent-flow interference portion 50 of the axial fan 30 and the turbulent-flow interference portion 50 of the bell mouth 40. Thus, when pressure fluctuations occur in the air flowing between the bell mouth 40 and the axial fan 30, turbulent flow readily passes through the pressure-fluctuating-element passing part 60. This minimizes the wind noise caused by surface vortex.

(1-4) The porous part 61 is arranged in a portion of the blade 32 located within 70% of the radius R of the axial fan 30 from the rotation shaft 12a in the radial direction of the axial fan 30.

With this structure, the porous part 61 is located rearward from the leading edge 33a of the blade 32 by 40% or more of the first dimension L1 and within 70% of the radius R of the axial fan 30 from the rotation shaft 12a. This reduces the noise generated near the trailing edge 33b of the blade 32.

(1-5) The area of the porous part 61 is less than or equal to 30% of the area of the blade 32.

This structure maintains the strength of the blade 32 as compared to a structure in which the porous part 61 is arranged in a wider range of the blade 32.

(1-6) The pressure-fluctuating-element passing part 60 includes the pores extending through the blade 32 or the bell mouth 40 in respective thickness-wise direction. The pores have an average pore diameter of 1000 μm or less.

When pressure fluctuations occur, this structure avoids a situation in which an excessive amount of air passes through the pressure-fluctuating-element passing part 60 while allowing passage of the air in the vicinity of the circumferential wall 41 through the pressure-fluctuating-element passing part 60. This reduces loss of the air flowing through the axial fan 30.

(1-7) When the bell mouth 40 includes the pressure-fluctuating-element passing part 60 within the range of the turbulent-flow interference portion 50, the pressure-fluctuating-element passing part 60 is arranged intermittently in the circumferential direction of the bell mouth 40.

This structure maintains the strength of the bell mouth 40 as compared to a structure in which the pressure-fluctuating-element passing part 60 is continuously arranged in the circumferential direction of the bell mouth 40.

(1-8) The outdoor unit 10 includes the fan unit 20.

When pressure fluctuations occur in the air flowing between the bell mouth 40 and the axial fan 30, this structure allows turbulent flow to readily pass through the pressure-fluctuating-element passing part 60. This minimizes the wind noise caused by the surface vortex.

### Second Embodiment

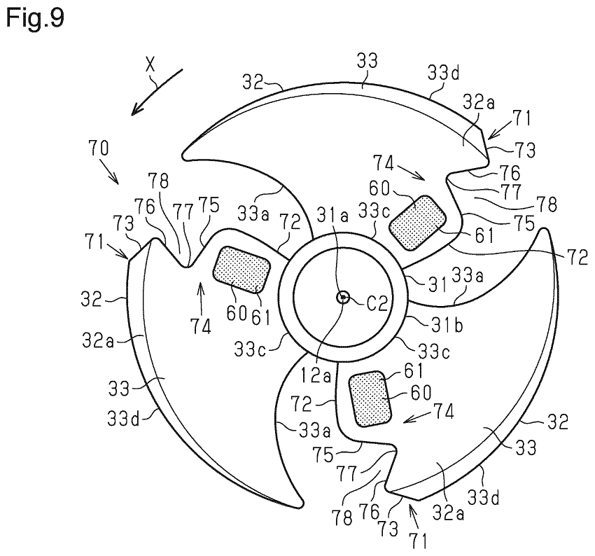

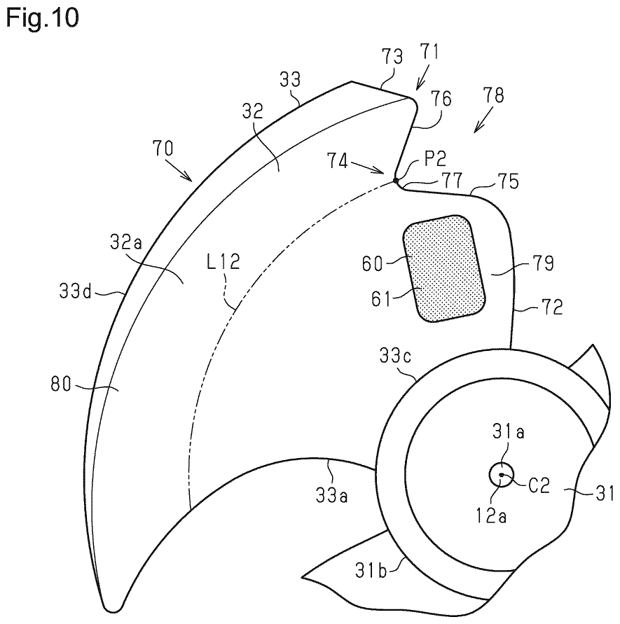

A second embodiment of the fan unit 20 will now be described with reference to FIGS. 9 and 10. In the second embodiment, the differences from the first embodiment will be described. The same reference names are given to those elements that are the same as the corresponding elements of the first embodiment, and such elements will not be described in detail.

As shown in FIGS. 9 and 10, a trailing edge 71 of an axial fan 70 in accordance with the second embodiment includes an inner peripheral connecting part 72, an outer peripheral connecting part 73, and a notch defining part 74. The inner peripheral connecting part 72 is connected to the inner peripheral edge 33c. The inner peripheral connecting part 72 extends from the inner peripheral edge 33c toward the notch defining part 74. The inner peripheral connecting part 72 is inclined toward the trailing side with respect to the rotation direction X of the axial fan 70 as the inner peripheral connecting part 72 approaches the notch defining part 74 from the inner peripheral edge 33c.

The outer peripheral connecting part 73 is connected to the outer peripheral edge 33d. The outer peripheral connecting part 73 extends from the notch defining part 74 toward the outer peripheral edge 33d. The outer peripheral connecting part 73 is inclined toward the trailing side with respect to the rotation direction X of the axial fan 70 as the outer peripheral connecting part 73 approaches the notch defining part 74 from the outer peripheral edge 33d.

The notch defining part 74 is located between the inner peripheral connecting part 72 and the outer peripheral connecting part 73. The notch defining part 74 connects the inner peripheral connecting part 72 and the outer peripheral connecting part 73. The notch defining part 74 includes a first section 75, a second section 76, and a third section 77.

The first section 75 is connected to the inner peripheral connecting part 72. The first section 75 extends from the inner peripheral connecting part 72 toward the leading edge 33a. The first section 75 is inclined toward the leading side with respect to the rotation direction X of the axial fan 70 as the first section 75 approaches the outer peripheral edge 33d from the inner peripheral connecting part 72.

The second section 76 is connected to the outer peripheral connecting part 73. The second section 76 extends from the outer peripheral connecting part 73 toward the leading edge 33a. The second section 76 is inclined toward the leading side with respect to the rotation direction X of the axial fan 70 as the second section 76 extends away from the outer peripheral connecting part 73. The distance between the first section 75 and the second section 76 decreases toward the leading edge 33a.

The third section 77 connects the first section 75 and the second section 76. The third section 77 is curved so as to be recessed toward the leading edge 33a. A region defined by the first section 75, the second section 76, and the third section 77 is the notch 78. The notch defining part 74 defines the notch 78. The notch 78 is arranged to improve airflow and reduce noise. The notch 78 extends between the positive pressure surface 32a and the negative pressure surface 32b. The notch 78 is recessed toward the leading edge 33a.

As shown in FIG. 10, an imaginary line that extends in the rotation direction X through a center position P2 of the third section 77 will be referred to as a trajectory L12. The center position P2 of the third section 77 is a point of the notch defining part 74 that is closest to the leading edge 33a. A portion of the blade 32 located closer to the inner peripheral edge 33c than the trajectory L12 is to the inner peripheral edge 33c will be referred to as an inner peripheral region 79. A portion of the blade 32 located closer to the outer peripheral edge 33d than the trajectory L12 is to the outer peripheral edge 33d will be referred to as an outer peripheral region 80. The inner peripheral region 79 includes the trajectory L12.

When the trailing edge 33b includes the notch 78, the porous part 61 is arranged in a portion of the blade 32 located closer to the rotation shaft 12a than the notch 78 is to the rotation shaft 12a in the radial direction of the axial fan 30. The porous part 61 is arranged, for example, in a portion of the blade 32 located closer to the inner peripheral edge 33c than the trajectory L12 is to the inner peripheral edge 33c. Preferably, the porous part 61 is arranged between the first section 75 and the inner peripheral edge 33c of the blade 32 in the radial direction of the axial fan 30.

Table 2 indicates a difference in the noise reduction effect of the fan unit 20 including the axial fan 70 of the second embodiment when the pressure-fluctuating-element passing part 60 is arranged in both the turbulent-flow interference portion 50 of the bell mouth 40 and the turbulent-flow interference portion 50 of the blade 32, and the porous part 61 is located on different positions of the turbulent-flow interference portion 50 of the blade 32. The “Noise Reduction Effect” of Table 2 indicates values representing the reduced noise. The “Combined Use” of Table 2 refers to a case in which the pressure-fluctuating-element passing part 60 was arranged in both the bell mouth 40 and the blade 32. In a third example of Table 2, the position of the porous part 61 on the turbulent-flow interference portion 50 of the blade 32 was in the outer peripheral region 80 of the blade 32. In a fourth example of Table 2, the position of the porous part 61 on the turbulent-flow interference portion 50 of the blade 32 was in the inner peripheral region 79 of the blade 32 located in the trailing edge section 35.

As the second row of Table 2 indicates, when the pressure-fluctuating-element passing part 60 was arranged in only the turbulent-flow interference portion 50 of the bell mouth 40, the value representing the noise reduction effect was 1.8 dBA. When the pressure-fluctuating-element passing part 60 was arranged in only the turbulent-flow interference portion 50 of the blade 32 located in the outer peripheral region 80, the value representing the noise reduction effect was 0.5 dBA. When the pressure-fluctuating-element passing part 60 was arranged in both the turbulent-flow interference portion 50 of the bell mouth 40 and the turbulent-flow interference portion 50 of the blade 32 located in the outer peripheral region 80, the value representing the noise reduction effect was 2.1 dBA. In the third example, when the pressure-fluctuating-element passing part 60 was arranged in both the turbulent-flow interference portion 50 of the bell mouth 40 and the turbulent-flow interference portion 50 of the blade 32 located in the outer peripheral region 80, the value representing the noise reduction effect was less than a value obtained by adding the values of the noise reduction effect when the pressure-fluctuating-element passing part 60 was arranged in only one of the turbulent-flow interference portion 50 of the bell mouth 40 and the turbulent-flow interference portion 50 of the blade 32 located in the outer peripheral region 80.

As the fourth row of Table 1 indicates, when the pressure-fluctuating-element passing part 60 was arranged in only the turbulent-flow interference portion 50 of the bell mouth 40, the value representing the noise reduction effect was 1.8 dBA. When the pressure-fluctuating-element passing part 60 was arranged in only the turbulent-flow interference portion 50 of the blade 32 located in the trailing edge section 35 and within the inner peripheral region 79, the value representing the noise reduction effect was 1.0 dBA. When the pressure-fluctuating-element passing part 60 was arranged in both the turbulent-flow interference portion 50 of the bell mouth 40 and the turbulent-flow interference portion 50 of the blade 32 located in the trailing edge section 35 and within the inner peripheral region 79, the value representing the noise reduction effect was 3.3 dBA. In the fourth example, when the pressure-fluctuating-element passing part 60 was arranged in both the turbulent-flow interference portion 50 of the bell mouth 40 and the turbulent-flow interference portion 50 of the blade 32 located in the trailing edge section 35 and within the inner peripheral region 79, the value representing the noise reduction effect was greater than a value obtained by adding the values of the noise reduction effect when the pressure-fluctuating-element passing part 60 was arranged in only one of the turbulent-flow interference portion 50 of the bell mouth 40 and the turbulent-flow interference portion 50 of the blade 32 located in the trailing edge section 35 and within the inner peripheral region 79.

TABLE 2

| | Pressure-Fluctuating- | Outer | | |
|---|---|---|---|---|
| | Element Passing Part | Peripheral | Bell | Combined |
| | Arrangement Position | Region | Mouth | Use |
| 3rd | Noise Reduction | 0.5 | 1.8 | 2.1 |
| Example | Effect (dBA) | | | |
| | | Trailing Edge | | |
| | | Section | | |
| | Pressure-Fluctuating- | and Inner | | |
| | Element Passing Part | Peripheral | Bell | Combined |
| | Arrangement Position | Region | Mouth | Use |
| 4th | Noise Reduction | 1.0 | 1.8 | 3.3 |
| Example | Effect (dBA) | | | |

### Advantages of the Second Embodiment

The second embodiment has the following advantages in addition to the advantages of the first embodiment.

(2-1) When the trailing edge 71 includes the notch 78, the porous part 61 is arranged in a portion of the blade 32 located closer to the rotation shaft 12a than the notch 78 is to the rotation shaft 12a in the radial direction of the axial fan 30.

With this structure, the porous part 61 is arranged in a portion located closer to the rotation shaft 12a than the notch 78 is to the rotation shaft 12a in the radial direction. This reduces the noise generated near the trailing edge 71 of the blade 32.

### Third Embodiment

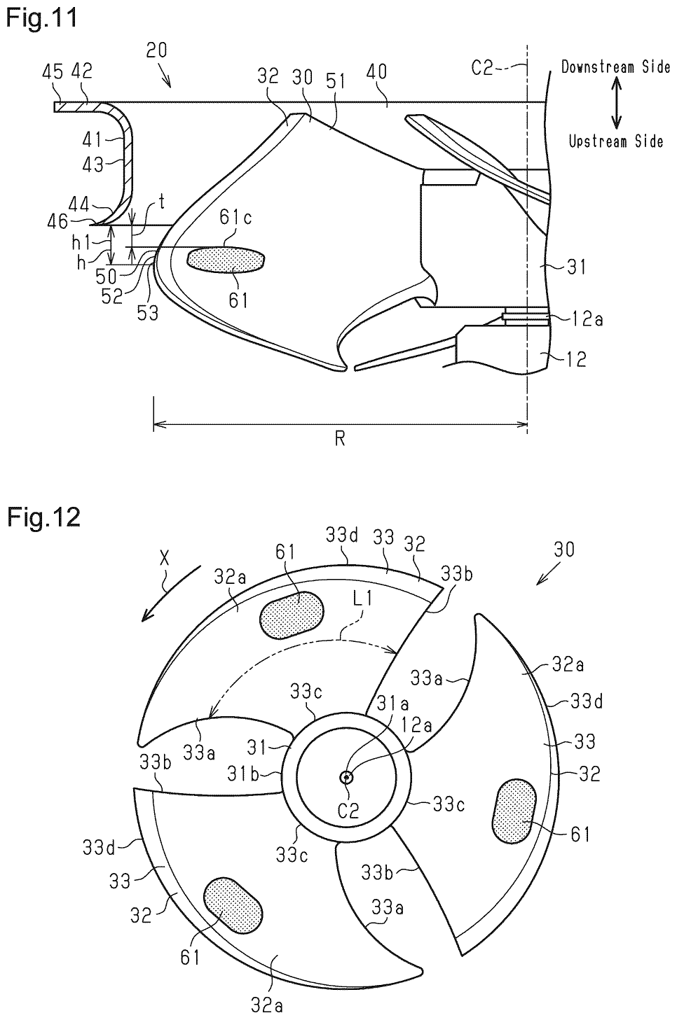

A third embodiment of the fan unit 20 will now be described with reference to FIGS. 11 to 14. In the third embodiment, differences from the first and second embodiments will be described. The same reference names are given to those elements that are the same as the corresponding elements of the first and second embodiments, and such elements will not be described in detail.

As shown in FIGS. 11 and 12, the blade 32 includes the porous part 61, and the bell mouth 40 does not include the porous part 61. The porous part 61 is arranged in, for example, the body 33 of the blade 32. In FIGS. 11 and 12, the porous part 61 arranged in the blade 32 is dotted.

The porous part 61 is substantially elliptical. The porous part 61 does not have to be elliptical, and may be circular or quadrangular. When the porous part 61 is elliptical, a ratio of the length of the major axis to the length of the minor axis is in a range of 1.3 to 1.8, inclusive.

The porous part 61 is arranged such that the center of the porous part 61 is located within a region that is defined by a circle having a predetermined radius and centered on the center of gravity of the blade 32. The predetermined radius is smaller than the radius R of the axial fan 30. Preferably, the porous part 61 is arranged such that the center of the porous part 61 coincides with the center of gravity of the blade 32.

In the present embodiment, the extension part 52 of the turbulent-flow interference portion 50 located at the upstream side of the overlapping part 51 will be defined as a first extension part 53. The first extension part 53 extends from the upstream end 46 of the bell mouth 40 toward the upstream side of the airflow generated by the axial fan 30. A length h1 of the first extension part 53 is 0.1 times the radius R of the axial fan 30. Hereinafter, a region defined by the first extension part 53 will be referred to as a first extension region.

The porous part 61 is arranged in the blade 32 such that the porous part 61 is partially located in the first extension region. The porous part 61 is arranged in the blade 32 such that a third end 61c of the porous part 61 that is closest to the upstream end 46 of the bell mouth 40 is located in the first extension region. A length t from the upstream end 46 of the bell mouth 40 to the third end 61c is less than or equal to the length h1 of the first extension part 53.

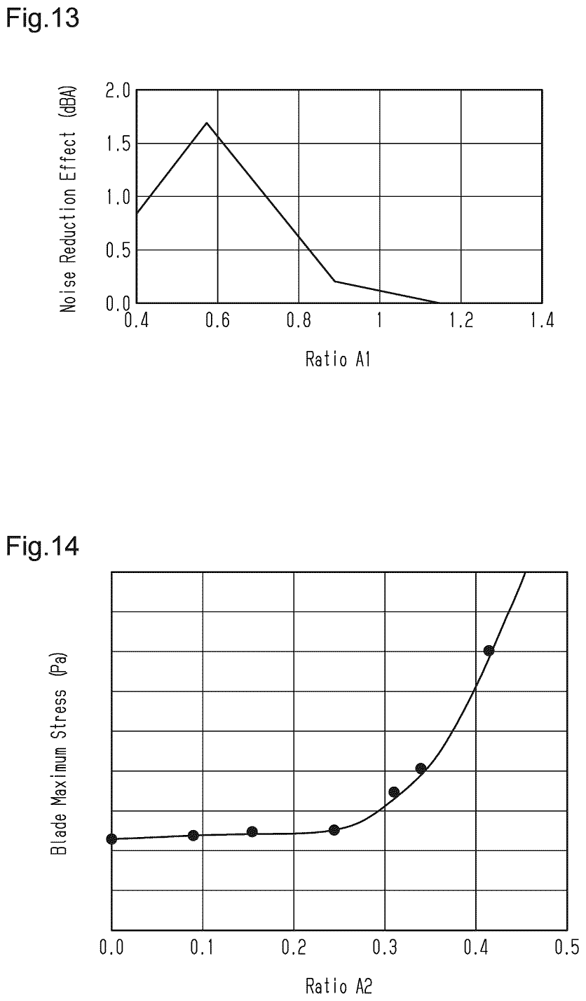

The relationship between the noise reduction effect and a ratio A1 will now be described with reference to FIG. 13. The ratio A1 is a ratio of the length t from the upstream end 46 of the bell mouth 40 to the third end 61c relative to the length h1 of the first extension part 53. FIG. 13 shows the level of the noise reduction effect with respect to the ratio A1. The graph in FIG. 13 was obtained through experiments. As shown in FIG. 13, the wind noise was reduced when the ratio A1 was set in a range of 0.4 to 0.9, inclusive. In particular, the wind noise was minimized when the ratio A1 was set in a range of 0.5 to 0.7, inclusive. Therefore, it is preferred that the ratio A1 be set in a range of 0.5 to 0.7, inclusive.

The area of the porous part 61 is less than the area of the blade 32. The area of the porous part 61 is less than or equal to 30% of the area of the blade 32. The area of the porous part 61 is, for example, less than or equal to 30% of the entire area of the positive pressure surface 32a. In other words, a ratio A2 of the area of the porous part 61 to the area of the blade 32 is less than or equal to 0.3. The ratio of the area of the porous part 61 to the entire area of the positive pressure surface 32a is, for example, less than or equal to 0.3.

Preferably, the area of the porous part 61 is less than or equal to 25% of the area of the blade 32. The area of the porous part 61 is, for example, less than or equal to 25% of the entire area of the positive pressure surface 32a. In other words, the ratio A2 is less than or equal to 0.25. The ratio of the area of the porous part 61 to the entire area of the positive pressure surface 32a is, for example, less than or equal to 0.25.

The relationship of the ratio A2 and maximum stress on the blade 32 will now be described with reference to FIG. 14. FIG. 14 shows the level of maximum stress on the blade 32 with respect to the ratio A2. The graph in FIG. 14 was obtained through experiments. As shown in FIG. 14, the maximum stress on the blade 32 was maintained when the porous part 61 arranged in the blade 32 had the ratio A2 of 0.3 or less. In particular, the maximum stress on the blade 32 was maintained effectively when the porous part 61 arranged in the blade 32 had the ratio A2 of 0.25 or less. Therefore, it is preferred that the porous part 61 arranged in the blade 32 have the ratio A2 of 0.25 or less.

Preferably, the porous part 61 is located at a position rearward from the leading edge 33a by 40% or more of the first dimension L1. The porous part 61 is arranged in a portion of the blade 32 located within 70% of the radius R of the axial fan 30 from the rotation shaft 12a in the radial direction.

The trailing edge 33b of the blade 32 may include the notch 78. When the trailing edge 33b includes the notch 78, the porous part 61 is arranged in a portion of the blade 32 located closer to the rotation shaft 12a than the notch 78 is to the rotation shaft 12a in the radial direction.

### Modified Examples

In addition to the embodiments described above, the fan unit 20 and the outdoor unit 10 according to the present disclosure are applicable to modified examples that are described below and combinations of at least two of the modified examples that do not contradict each other.

The outdoor unit 10 may be an outdoor unit of a heat pump water heater that generates hot water by refrigeration cycle and stores the generated hot water.

The pressure-fluctuating-element passing part 60 may be arranged in only the axial fan 30. The pressure-fluctuating-element passing part 60 may be arranged in only the bell mouth 40.

The circumferential wall 41 of the bell mouth 40 does not have to include the cylindrical portion 43. The circumferential wall 41 of the bell mouth 40 may be formed by the blow-out portion 42 and the suction portion 44 that are continuous with each other.

The pressure-fluctuating-element passing part 60 and the porous part 61 may each be a porous body having a large number of through holes extending in a single direction. The porous body having a large number of through holes extending in a single direction may be prepared, for example, by inserting a needle-shaped member through a solid resin body a number of times from one direction.

In the third embodiment, the porous part 61 may be arranged in the bell mouth 40, in addition to the blade 32. In this modified example, the porous part 61 is arranged intermittently in the circumferential direction of the bell mouth 40 within the range of the turbulent-flow interference portion 50 of the bell mouth 40.

It should be understood that the fan unit 20 and the outdoor unit 10 according to the above disclosure may be embodied in many other specific forms within the scope and equivalence of the present disclosure described in the appended claims.

1. A fan unit, comprising:
an axial fan; and
a bell mouth,
the axial fan including
a hub attached to a rotation shaft,
a blade arranged on the hub, and
a turbulent-flow interference portion,
the turbulent-flow interference portion including
an overlapping part where the blade overlaps the bell mouth in a radial direction of the axial fan, and
an extension part located at two opposite sides of the overlapping part in an axial direction of the axial fan,
a length of the extension part in the axial direction being less than or equal to 0.1 times a radius of the axial fan,
the blade including a porous part within a range of the turbulent-flow interference portion, and
an area of the porous part being less than or equal to 30% of an area of the blade.

2. The fan unit according to claim 1, wherein
the area of the porous part is less than or equal to 25% of the area of the blade.

3. The fan unit according to claim 1, wherein
the blade includes
a leading edge located forward with respect to a rotation direction of the rotation shaft, and
a trailing edge located rearward with respect to the rotation direction of the rotation shaft, and
when a dimension from the leading edge to the trailing edge is a first dimension, the porous part is located at a position rearward from the leading edge by 40% or more of the first dimension.

4. The fan unit according to claim 1, wherein
the porous part is arranged in a portion of the blade located within 70% of the radius of the axial fan from the rotation shaft in the radial direction.

5. The fan unit according to claim 1, wherein
the blade includes a trailing edge located rearward with respect to a rotation direction of the rotation shaft,
the trailing edge includes a notch, and
the porous part is arranged in a portion of the blade located closer to the rotation shaft than the notch is to the rotation shaft in the radial direction.

6. The fan unit according to claim 1, wherein
the porous part includes pores extending through the blade in a thickness direction, and the pores have an average pore diameter of 1000 μm or less.

7. The fan unit according to claim 1, wherein
the bell mouth includes the overlapping part,
the bell mouth includes the porous part within a range of the overlapping part, and
the porous part is arranged intermittently in a circumferential direction of the bell mouth.

8. An outdoor unit including the fan unit according to claim 1.
